(19) United States
(12) Patent Application Publication
(10) Pub. No.: US 2014/0266215 A1
(43) Pub. Date: Sep. 18, 2014

(54) SYSTEMS AND METHODS FOR MEASURING WATER PROPERTIES IN ELECTROMAGNETIC MARINE SURVEYS

(71) Applicant: PGS GEOPHYSICAL AS, Lysaker (NO)

(72) Inventors: Erik Bjornemo, Knivsta (SE); Johnathan Linfoot, Edinburgh (GB)

(73) Assignee: PGS Geophysical AS, Lysaker (NO)

(21) Appl. No.: 13/797,445

(22) Filed: Mar. 12, 2013

(51) Int. Cl. G01V 3/165

(52) U.S. Cl. CPC G01V 3/165
USPC 324/365

(57) ABSTRACT

Systems and methods for measuring water properties during a marine survey are disclosed. While electromagnetic-field (“EM-field”) receivers located along streamers towed by a survey vessel measure surrounding EM fields, horizontal conductivity profiles of a body of water located above a subterranean formation are also measured. By inputting a substantially continuous, conductivity profile of the body of water along with EM-field data into an EM inversion process, estimates of the subterranean formation properties, such as resistivities, can be generated with a higher degree of confidence than estimates of properties based on a speculated or sparse conductivities of the body of water.

### BACKGROUND

In recent years, marine electromagnetic (“EM”) survey technology has been used commercially to identify hydrocarbon-rich deposits in subterranean formations. EM survey techniques typically generate primary time-varying EM fields using bipole antennas as an EM-field source. The source is towed through a body of water by a survey vessel above a subterranean formation. The primary time-varying EM fields extend downward into the subterranean formation where they induce secondary currents that, in turn, generate secondary time-varying EM fields that can be sensed at various locations distributed across a relatively large area above the subterranean formation. Non-uniformities detected in the secondary EM fields result from non-uniform electrical resistance in various features within the formation. Hydrocarbons and hydrocarbon-saturated rocks and sediments have much higher resistivities than water and water-saturated rocks and sediments. High-resistance hydrocarbon-saturated rocks and sediments result in a non-uniform distribution of secondary current paths and concentration of electrical field lines in conductive portions of the formation above the pooled hydrocarbons and hydrocarbon-saturated rocks and sediments. By taking multiple measurements across a wide area for each of many different bipole-antenna locations, digitally encoded EM-survey data sets are generated and stored in data-storage systems, which are subsequently computationally processed in order to produce resistivity maps or images that indicate the longitudinal and latitudinal positions and depths of potential hydrocarbon-rich subterranean features. In many cases, three-dimensional resistivity maps or images of the subterranean formation are generated as a result of these data-processing operations. The maps and images produced from EM-survey data can be used alone or in combination with maps and images produced by other geophysical methods, including acoustic marine exploration seismic methods, to locate and confirm the presence of hydrocarbon deposits prior to undertaking the expense of marine-drilling operations to recover liquid hydrocarbon from subterranean formations. Those working in the petroleum industry continue to seek improvements to EM systems and methods for locating and confirming the presence of hydrocarbon deposits.

### DESCRIPTION OF THE DRAWINGS

FIGS. 1A-1B show a side-elevation view and a top view, respectively, of a marine electromagnetic (“EM”) surveying system.

FIG. 2 shows an example top view of a river that drains into a body of water which is being surveyed.

FIG. 3 shows a plot of one-dimensional EM inversion results from introducing resistivity errors into a water column above a subterranean formation.

FIG. 4A shows a side-elevation view of a marine EM survey system with a water-property-detection system located along a streamer-data-transmission cable.

FIG. 4B shows a top view of a marine EM survey system with water-property-detection systems located along streamers.

FIG. 5 shows a side-elevation view of a marine EM survey system with a water-property-detection system towed by a separate cable.

FIG. 6 shows a top view of a marine EM survey system operated with two survey vessels.

FIGS. 7A-7B show perspective and cross-sectional views of a water-property-detection system implemented with a paravane.

FIGS. 8A-8B show cross-sectional views of water-property-detection systems used in marine environments with varying conductivity.

FIG. 9 shows a flow diagram for processing EM-survey data using a marine EM survey system.

FIG. 10 shows an example of a generalized computer system that executes an efficient method for conducting EM surveys.

FIGS. 11A-11B show side-elevation and top views, respectively, of marine EM survey systems with water-property-detection systems attached to various components.

### DETAILED DESCRIPTION

Electromagnetic (“EM”) survey data is computationally processed to compute a rock property, typically resistivity, of a subterranean formation. This can be done using a data processing technique called EM inversion, which is a nonlinear computational process that requires constraints in how the processing is performed. EM inversion is performed with a series of forward simulations of property distributions, such as resistivities, of a subterranean formation that are calculated and compared with the measured EM-field data and a best fit model or range of models of the properties is determined. One method for improving the stability of EM inversion is to input properties of the body of water above a subterranean formation, structural layer boundaries, or confidence estimates on data values. High quality information input to an EM inversion process typically produces subterranean property estimates with a high level of confidence. However, when inaccurate or sparse properties of the body of water are input to EM inversion, incorrect subsurface estimates may be output.

Systems and methods for measuring water conductivity, temperature, and pressure along a trajectory during a marine survey are disclosed. While EM-field receivers located along streamers towed by a survey vessel measure surrounding EM fields, the conductivity, temperature, and pressure are measured along a trajectory in the body of water in order to determine conductivity of the water as a function of position. The trajectory is the path along which the conductivity, temperature, and pressure data are measured in the body of water as the survey vessel travels a vessel track. The temperature and pressure data are used to calculate the associated depth at which the conductivity is measured. By inputting substantially continuous conductivity and depth profiles of the body of water along with EM-survey data into EM inversion, estimates of the subterranean formation, such as resistivities, are generated with a higher degree of confidence than estimates based on speculated or sparse conductivity, temperature, and pressure data.

Processing water-property data (conductivity, temperature, and pressure data) and EM survey data in near-real time while conducting an EM survey is valuable for quality control (“QC”) purposes. Water-property data can be used to correct and/or detect errors in the QC process in previous data acquisition and direct subsequent data acquisition. These benefits are particularly valuable in marine EM surveys, where delays caused by having to redo an EM survey are extremely expensive. Various parts of QC and data processing (e.g., noise reduction) make use of geophysical information, such as a precisely measured water conductivity profile to stabilize EM inversion. For example, at short offsets (i.e., horizontal distance from a EM-field source midpoint to EM-field receiver midpoint), errors in the water conductivity translate into large errors in modelled (expected) signals used for reference in QC and as constraints in noise reduction. The term “near-real time” refers to a time delay due to data transmission and data processing that is short enough to allow timely use of the processed data during further data acquisition. For example, near-real time can refer to a situation in which the time delay due to transmission and processing is insignificant relative to the overall data acquisition time. In other words, near-real time approximates real time when the time for data transmission and data processing appears imperceptible. Near-real time can also refer to a perceptible time delay for data transmission and data processing but the time delay is not so long that QC cannot be executed. Although the following description is directed to systems and methods for acquiring water-property data during an EM survey, the water-property data and EM-field data can be transmitted and processed in near-real time for QC and to generate EM inversion output.

FIGS. 1A-1B show a side-elevation view and a top view, respectively, of a marine EM surveying system composed of a survey vessel 102 towing an EM-field source 104 and six separate streamers 106-111 located beneath a free surface 112 of a body of water. The body of water can be a region of an ocean, a sea, a lake, a river, or a river delta. As illustrated, the source 104 includes two source electrodes 114 located at opposite ends of a cable 116, which is connected to the survey vessel via a source lead-in cable 118. In the example of FIG. 1A-1B, the source electrodes 114 and the cable 116 form a long horizontally oriented electric bipole transmission antenna. The source 104, shown in FIGS. 1A-1B, is not intended to be limited to a horizontal arrangement of the cable 116 and electrodes 114. The cable 116 may also include, in addition to or in substitution of the horizontally oriented electrodes 114, any one or more of a vertical electric bipole antenna, and horizontal or vertical magnetic bipole antenna (current loop).

In this example, each of the streamers 106-111 is attached at one end to the survey vessel 102 via a streamer-data-transmission cable and at the opposite end to a buoy, such as a buoy 120 attached to the steamer 109. In the example of FIGS. 1A-1B, the streamers 106-111 form a planar horizontal receiver acquisition surface located beneath the free surface 112. However, in practice, the receiver acquisition surface can be smoothly varying due to active sea currents and weather conditions. In other words, although the streamers 106-111 are illustrated in FIGS. 1A and 1B as being straight, in practice, the towed streamers may undulate as a result of dynamic conditions of the body of water in which the streamers are submerged. It should be noted that a receiver acquisition surface is not limited to having a horizontal orientation with respect to the free surface 112. The streamers may be towed at depths that orient the receiver acquisition surface at an angle with respect to the free surface 112 or so that one or more of the streamers are towed at different depths. It should also be noted that a receiver acquisition surface is not limited to six streamers. In practice, a receiver acquisition surfaces can be composed of as few as one streamer to as many as 20 or more streamers.

FIG. 1A includes an xz-plane 122 and FIG. 1B includes an xy-plane 124 of the same Cartesian coordinate system having three orthogonal, spatial coordinate axes labeled x, y and z. The coordinate system is used to specify orientations and coordinate locations within a body of water. The x-direction specifies the position of a point in a direction parallel to the length of the streamers and is referred to as the “in-line” direction. The y-direction specifies the position of a point in a direction perpendicular to the x-axis and substantially parallel to the free surface 112 and is referred to as the “cross-line” direction. The z-direction specifies the position of a point perpendicular to the xy-plane (i.e., perpendicular to the free surface) with the positive z-direction pointing downward away from the free surface 112. Streamer depth below the free surface 112 can be estimated at various locations along the streamers using depth measuring devices attached to the streamers. For example, the depth measuring devices can measure hydrostatic pressure or utilize acoustic distance measurements. The depth measuring devices can be integrated with depth controllers, such as paravanes or water kites, that control the depth and position of the streamers as the streamers are towed through a body of water. The depth measuring devices are typically placed at about 300 meter intervals along each streamer. Note that in other embodiments the buoys can be omitted and depth controllers alone can be used to maintain the orientation and depth of the streamers below the free surface 112. For example, buoys are often used in shallow water surveys and streamers without buoys are typically used in deeper surveys (e.g., for depths greater than 50 meters). In other embodiments, the source 104 may be towed by a separate vessel from the survey vessel used to tow the streamers 106-111. The source 104 can be anywhere from approximately 50 to 800 meters long or longer and is generally towed, in certain types of EM data-collection methods, at a depth of approximately 5 to 100 meters below the free surface 106. The streamers are towed at a lower depth of approximately 5 to 500 meters below the free surface 106.

FIG. 1A shows a cross-sectional view of the survey vessel 102 towing the source 104 and streamers above a subterranean formation 126. Curve 128 represents a solid surface at the bottom of a body of water located above the subterranean formation 126. The subterranean formation 126 is composed of a number of subterranean layers of sediment and rock. Curves 130, 132, and 134 represent interfaces between subterranean layers of different compositions. A shaded region 136, bounded at the top by a curve 138 and at the bottom by a curve 140, represents a hydrocarbon-rich subterranean deposit. As the survey vessel 102 moves over the subterranean formation 126 an EM survey of the subterranean formation 126 is carried out by transmitting time-varying electrical currents between the electrodes 114 of the source 104. The time-varying currents, of magnitudes generally from hundreds to thousands of amperes, generate an EM field that radiates outward from the source 104 as a primary EM field. The EM-field wavefronts are, in effect, shown in vertical plane cross section in FIG. 1A and are represented by curves 142 that pass from the source 104 into the body of water and into the subterranean formation 116. In certain EM surveys, the transmission currents have binary wave forms with a fundamental frequency of approximately 0.1 to approximately 0.25 Hz. The primary EM fields generate secondary, subterranean electric currents that, in turn, produce a secondary EM field, represented by curves 144, that is radiated back into the body of water. In other techniques, including inductively coupled time-domain EM, the transmission current is steadily ramped up to a relatively high, steady-on current value and then rapidly extinguished, leading to an electromotive force (“emf”) impulse that generates secondary EM eddy currents in the subterranean formation which decay via Ohmic dissipation and produce weak, relatively short-lived secondary magnetic fields.

As shown in FIGS. 1A-1B, the streamers 106-111 include EM-field receivers 146 that measure, for example, the magnitude of the primary and secondary EM fields and may additionally measure phases of the secondary EM fields generated by the primary, time-varying EM-field output from the source 104. Receiver position data can be obtained in one embodiment because the receivers are towed behind the moving survey vessel 102 and continuously sampling the EM fields, and the global positioning receivers located on board the survey vessel 102 or located on source buoys (not shown) can be used in conjunction with streamer compasses and/or acoustic positioning devices to determine the positions of the receivers 146. Any other technique for obtaining receiver position data may be used instead of or in conjunction with the global positioning receivers, streamer compasses, and acoustic positioning devices. Receiver position data correlated with receiver output reflects the instantaneous magnitude and phase of the EM field measured at the current receiver position. The receivers convert the measured EM fields into signals that can be sent to the survey vessel along streamer-data-transmission cables and stored in data processing equipment located on board the survey vessel 102 as EM-field data. The EM-field data can be further processed using EM inversion to produce three-dimensional maps of the subterranean formation electrical and magnetic properties. In other embodiments, magnetometers can also be used to measure magnetic components of the primary and secondary EM fields.

A significant part of the response of the subterranean formation 126 to the EM fields is the “airwave,” which is a part of the EM-field energy that travels through the upper water layers and in the air above the free surface 112 between the source 104 and the receivers 146. Similarly, a large contribution to the EM field measured by the receivers is from the EM-field energy that travels to the water bottom 118 and then back to the free surface 112 (i.e., multiples). For short source 104 to receiver 146 distances, there is also a considerable contribution to the EM field from the water-only path called the “direct response.” The magnitude of these responses is determined to a very high degree by the conductivity structure of the water column through which the source 104 and streamers 106-111 are towed. Conductivity is a measure of the ability of water to pass an electric current and is affected by the presences of dissolved materials. Conductivity is also affected by the temperature of the water: the warmer the water the higher the conductivity and, conversely, the colder the water the lower the conductivity. The amount by which the conductivity of a body of water varies across a survey area can be extreme. FIG. 2 shows an example of a river 202 that drains into a large body of water 204 that can be an ocean or lake. Conductivity in streams and rivers is affected by the geology of the area through which the water flows. Rivers that run through areas with granite bedrock tend to have a lower conductivity than rivers that run through areas with clay solids, because granite is composed of more inert materials that do not ionize when washed into water whereas clay solids and other nutrients ionize when washed into water. FIG. 2 includes contours 206-209 along which the conductivity of the water outside the river outlet is constant. In this example illustration, the river 202 carries a large concentration of ionizable materials into the body of water 204 which has a lower concentration of ionizable materials. As a result, the contours 206-209 represent how the conductivity gradually decreases away from the river outlet with the contour 206 having a higher conductivity than the contour 209. FIG. 2 also includes dashed lines 210-212 that represent vessel tracks of an EM survey. As an EM survey system 214 travels along vessel track 211 in the direction 216, the receivers pass through water with gradually increasing conductivity before passing through water with gradually decreasing conductivity.

The airwave-direct response is not of primary interest in EM surveying, but the airwave response can have noticeable impact on EM inversion performance. In particular, a poorly derived conductivity structure can create artifacts in a resistivity map produced by EM inversion. As a result, water-conductivity errors can translate into sediment and target errors and disturb the primary regions of interest, such as hydrocarbon deposits. An unknown water conductivity profile also means unknown parameters that pre-EM inversion signal processing makes allowances for, resulting in uncertainties and degrades resistivity precision and accuracy. All relevant water-property information, such as water conductivity, can be helpful in providing additional constraints on EM inversion that improves the estimation of electrical and magnetic properties of a subterranean formation. Tighter constraints for the processing can also lead to improved noise suppression. For example, the more a priori water-property information input to EM inversion constrains the range of possible resistivities output and the better noise can be distinguished from signal. When additional water-property information is available, the number of unknown parameters used by EM inversion to compute electrical and magnetic properties of a subterranean formation is reduced. By having conductivity data and associated depths as input to EM inversion, the computational process of estimating the electrical and magnetic properties of a subterranean formation is more reluctant to accept noise as a part of the computational process.

FIG. 3 shows a plot of one-dimensional EM inversion results from introducing resistivity errors into a water column above a subterranean formation. Horizontal axis 302 represents depth within the subterranean formation beneath the water column, and vertical axis 304 represents log resistivity. EM inversion was performed on a column of fresh and sea water and resistivities in the column were varied. The plot shows results from five separate one-dimensional models. The results represented by dashed lines 306 represent a model from an accurate sea water resistivity. The results represented by other line patterns have some error in the resistivity of the water column. The results demonstrate how errors in resistivities of the water column lead to dramatically different results for resistivities in the subterranean formation.

Returning to FIGS. 1A-1B, the EM survey system includes a water-property-detection system 148 located along the lead-in cable 118 for the source 104. Magnified view 150 reveals an example of the detection system 148 composed of a conductivity sensor 152, a temperature sensor 154, and a pressure sensor 156. Each of the sensors 152, 154, and 156 is connected to data processing equipment located on board the survey vessel via the lead-in cable 118. The sensors 152, 154, and 156 measure water properties along a trajectory that is generally substantially parallel to the vessel track the survey vessel 102 follows and transmit sensor data to the data processing equipment based on time or distance. For example, the sensors 152, 154, and 156 can sample water properties at a substantially continuous sampling rate of about 10-40 Hz or at regularly spaced points along a vessel track. Examples of faster sampling rates include ranges of about 0.01 to 1 Hz or sample spacings of about 2 to 200 meters. The conductivity sensor 152 can be composed of two electrodes or coils to which a voltage is applied. For example, when the two electrodes are submerged in the body of water and a voltage is applied, changes in voltage caused by the resistance of the water are transmitted back to the data processing equipment and used to calculate the conductivity of the water. The temperature sensor 154 can be an electronic thermometer that transmits the temperature back to the data processing equipment, and the pressure sensor 156 can be hydrostatic pressure measuring device, such as a hydrophone, that measures and transmits the hydrostatic pressure back to the data processing equipment. Salinity and sound speed can be calculated from the conductivity, temperature, and pressure, which, in turn, can be used to calculate the depth of the sensors 152, 154, and 156 below the free surface 112. The conductivity, temperature, and pressure data are stored in the data processing equipment memory and can be correlated with position and time that can be determined from a GPS receiver located on board the survey vessel 102 or the source 104 buoy. The three-dimensional position of the conductivity, temperature, and pressure data can be correlated with the position of the EM fields measured by the receivers.

The water-property-detection system 148 is not limited to having the three sensors 152, 154, and 156. In practice, the detection system 148 may be composed of a combination of the sensors 152, 154, and 156, where one or two of the sensors are omitted. For example, the detection system 148 can be composed of the conductivity sensor 152 alone, the conductivity sensor 152 and the temperature sensor 154, or the conductivity sensor 152 and the pressure sensor 156.

A water-property-detection system is also not limited to being located along the lead-in cable 118 to the source 104. A water-property-detection system can be located along one of the streamer-data-transmission cables of the streamers 106-111. FIG. 4A shows a side-elevation view of a marine EM survey system with a water-property-detection system located along a streamer-data-transmission cable. The EM survey system is similar to the EM survey system shown in FIGS. 1A-1B, except rather than the detection system being located along the lead-in cable 118 to the source 104, as shown in FIGS. 1A-1B, a water-property-detection system 404 is located along a streamer-data-transmission cable 402 that leads from the survey vessel 102 to the streamer 109. The detection system 404 can be composed of a conductivity sensor, a temperature sensor, and a pressure sensor, or any combination of the conductivity sensor with the temperature sensor and/or pressure sensor, as described above. The detection system 404 generally follows a trajectory that is substantially parallel to the vessel track traveled by the survey vessel 102. Signals generated by the sensors of the detection system 404 are transmitted along the transmission cable 402 to data processing equipment located on board the survey vessel 102. It should be noted that water-property-detection systems can be located on, or suspended from, one or more streamer-data-transmission cables and are not intended to be limited to being located along just one transmission cable. In other embodiments, the water-property-detection system 404 can be located along the streamer 109, or a water-property-detection system can be located along each of the streamers 106-111. FIG. 4B shows a top view of a marine EM survey system with a water-property-detection system 406 located along each of streamers 106-111. In still other embodiments, water-property-detections systems can be suspended from any number of the streamer-data-transmission cables and any number of the streamers. The detection systems generally follow trajectories that are substantially parallel to the vessel track traveled by the survey vessel 102.

A water-property-detection system can also be towed by a detection-system cable that is separate from the lead-in cable 118, the streamer-data-transmission cables, and the streamers 106-111. FIG. 5 shows a side-elevation view of a marine EM survey system with a water-property-detection system 502 towed by a detection-system cable 504 behind the survey vessel 102. The detection system 502 can be composed of a conductivity sensor, a temperature sensor, and a pressure sensor, or any combination of the conductivity sensor with the temperature sensor and/or pressure sensor, as described with reference to FIG. 1A. Signals generated by the sensors of the detection system 502 are transmitted along the cable 504 to data processing equipment located on board the survey vessel 102. Although the detection system 502 is shown as being towed at a depth between the source 104 and the streamer 109, the detection system 502 can also be towed above the source 104 or below the streamers of the data acquisition surface.

In other marine EM survey system embodiments, a water-property-detection system can be towed separate from the source and streamers. FIG. 6 shows a top view of a marine EM survey system operated with a first survey vessel 602 and a second survey vessel 604. The first survey vessel 602 tows a water-property-detection system 606 from a detection-system cable 608, and the second survey vessel 604 tows the source 104 and the streamers 610. In other embodiments, the water-property-detection system, source, and streamers can be towed by separate survey vessels. It should be noted that the first survey vessel 602 is towed close to or through approximately the same region of water the streamers of the second survey vessel 604 are towed through and that the survey vessel 602 and 604 are operating close in time.

Water-property-detection systems attached to detection-system cables can be implemented with paravanes or water kites that control the depth and trajectory of the detection systems. By implementing a water-property-detection system in a paravane, the trajectory can be changed in three dimensions because the position of the paravane can be changed in the yz-plane while the paravane continues to travel in the x-direction. In other words, the paravane (i.e., water-property-detection system) continues to travel in along the same trajectory as the source and sensors except when the survey vessel turns. When the survey vessel turns, such as during a coiled survey, the paravane can be repositioned to travel approximately the same trajectory as the source and sensors. FIGS. 7A-7B show a perspective view and a cross-sectional view of a water-property-detection system 702 implemented with a paravane 704. The detection system 702 includes a conductivity sensor, temperature sensor, and pressure sensor. The example paravane 704 is a weighted torpedo-shaped device that includes four independently operated fins, which are used to change the position of the paravane in three dimensions as the paravane 704 is towed through a body of water. Three of the four fins 706-708 are shown with the fourth fin located behind the body of the paravane 704. In FIG. 7A, the paravane 704 is suspended from suspension cables 710 and 712 that lead to a survey vessel (not shown) and includes a data transmission cable 714 that transmits sensor data from the sensors 702 to the survey vessel. The cross-sectional view of FIG. 7B reveals that the sensors 702 are connected to a computer 716, which, as illustrated, is also connected to and controls one or more motors 718 that control the position of the fins. The computer 716 can include one or more processors and memory to process and store sensor data generated by the sensors of the detection system 702 and transmit the data to data processing devices located on board the survey vessel. The computer 716 can also receive machine-readable instructions from the data processing devices located on board the survey vessel to change the position of the paravane 704. For example, conductivity, temperature, and pressure data can be used to determine the depth of the paravane and the depth can, in turn, be used to reposition the depth of the paravane 704 to follow a desired trajectory below the free surface. It should be noted that processing and storing sensor data may be operated by a separate computer from that which controls the position of the fins. In the illustrated embodiment, the sensors comprising the detection system 702 are suspended from the underside of the paravane 704. In other embodiments, the sensors can be located on the nose of a paravane or distributed around the circumference of the paravane.

Traditionally, water conductivity profiles are measured one or a few times per EM survey using recoverable or expendable profiling conductivity, temperature, and depth (“xCTD”) probes. xCTD probes are deployed vertically through a water column while measuring the conductivity, temperature and depth as the probe sinks to the water bottom where they are left on the water bottom floor. As a result, only snapshots of a conductivity profile in the survey area are obtained, but the coverage is in general very sparse and cannot account well for changes in between places where the xCTD probes are dropped. Additionally, leaving xCTD probes on the water bottom floor may create environmental concerns. By contrast, marine EM survey systems and methods described herein deploy one or more water-property-detection systems that can be used in an EM survey to determine water conductivity and/or temperature horizontally, and horizontally and vertically, in an essentially continuous manner. The term “horizontal” means in the xy-plane or substantially parallel to the free surface, and the term “vertical” means in the z-direction or substantially perpendicular to the free surface.

FIGS. 8A-8B show cross-sectional views of water-property-detection systems used in a marine environment with varying conductivity. In FIG. 8A, a survey vessel 802 tows a single water-property-detection system 804 along a vessel track of an EM survey below a free surface 806. The vessel track corresponds to the vessel track 211 shown in FIG. 2 with dashed lines 808-811 correspond to points 216-219 where the vessel track 211 intersects the contours 208 and 209. In FIG. 8A, the water conductivity is substantially constant vertically. Cable 812 can represent a lead-in cable for a source (not shown), a streamer-data-transmission cable for a streamer (not shown), or a detection-system cable that tows the detection system 804, wherein the detection system 804 may be implemented in a paravane as described above. As the survey vessel 802 follows the vessel track, the detection system is towed through the water, as represented by directional arrow 814, while the conductivity, temperature, and pressure are essentially continuously measured. For example, the conductivity, temperature, and pressure can be measured at a rate of between about 10-40 Hz along a substantially horizontal trajectory with a sustained depth below the free surface. When the detection system 804 is implemented in a paravane, the trajectory of the detection system 804 can be changed while the survey vessel 802 follows the vessel track. For example, while the survey vessel 802 follows the vessel track, the detection system 804 can be moved up and down (i.e., z-direction), as represented by directional arrows 816 and 818, or side to side (i.e., y-direction) while traveling in the x-direction and measuring the conductivity, temperate, and pressure. In other words, a single paravane implemented with a water-property-detection system can be operated in a manner that enables the conductivity, temperature, and pressure to be measured along a changing three-dimensional trajectory directed parallel to the vessel track traveled by the survey vessel.

In FIG. 8B, a survey vessel 820 tows four vertically spaced, water-property-detection systems 821-824 along a vessel track of an EM survey below a free surface 826. Dashed lines 828-830 represent water conductivity contours. A cable 832 that connects the detection system 821 can be a lead-in cable for a source, a streamer-data-transmission cable, or a separate detection-system cable that attaches the detection system 821 to the survey vessel 820, and the detection systems 822-824 can be implemented in paravanes connected by separate cables 833-835 to the survey vessel 820. As the survey vessel 820 follows the vessel track, the detection systems 821-824 are towed through the water, as represented by directional arrows 836-839, and used to horizontally and vertically measure the conductivity, temperature, and pressure in an essentially continuous manner as described above. The depths of the detection systems 822-824 can be controlled while the survey vessel 820 follows the vessel track as indicated by up and down directional arrows. When the detection system 821 is implemented in a paravane, the depth of the detection system 821 can also be controlled. Because the detection systems 821-824 can be implemented in paravanes, the detection systems 821-824 are not limited to measuring conductivity, temperature, and pressure in the same vertical plane (i.e., xz-plane). The paravanes 821-824 can also be distributed laterally (i.e., y-direction) as the survey vessel 820 travels a vessel track. In other words, any number of paravanes, each implemented with a water-property-detection system, can be spread out in three dimensions below the free surface as the survey vessel follows a vessel track and the trajectory of each paravane can be adjusted remotely, such as from the survey vessel.

FIG. 9 shows a flow diagram for processing EM-survey data using a marine EM survey system. In block 901, an EM source is towed by a survey vessel through a body of water located above a subterranean formation. The source can be discharged continuously or semi-continuously to generate a primary EM field. In block 902, primary and secondary EM fields are measured at streamer receivers to generate EM-field data that is transmitted from the receivers to data processing equipment located on board a survey vessel. In block 903, while the EM fields are being measured at the receivers towed by the streamers, one or more water-property-detection systems are used to measure conductivity, temperature, and depth; conductivity and temperature; or conductivity and depth. The one or more water-property-detection systems are deployed as described above. In block 904, conductivity, temperature, and depth data is position correlated with the EM-field data and the data are input to an EM inversion computational process to generate electrical and magnetic properties, such as resistivities and/or resistivity maps, of the subterranean formation. It should be noted that calculation of electrical and magnetic properties, such as resistivities and/or resistivity maps, can be performed in near-real time while the EM survey is being conducted.

FIG. 10 shows an example of a generalized computer system that executes efficient methods for conducting EM surveys and computing electrical properties of a subterranean formation described above and therefore represents a geophysical-analysis data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 1002-1005, one or more electronic memories 1008 interconnected with the CPUs by a CPU/memory-subsystem bus 1010 or multiple busses, a first bridge 1012 that interconnects the CPU/memory-subsystem bus 1010 with additional busses 1014 and 1016, or other types of high-speed interconnection media, including multiple, high-speed serial interconnects. The busses or serial interconnections, in turn, connect the CPUs and memory with specialized processors, such as a graphics processor 1018, and with one or more additional bridges 1020, which are interconnected with high-speed serial links or with multiple controllers 1022-1027, such as controller 1027, that provide access to various different types of computer-readable media, such as computer-readable medium 1028, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 1028 is a data-storage device, including electronic memory, optical or magnetic disk drive, USB drive, flash memory and other such data-storage device. The computer-readable medium 1028 can be used to store machine-readable instructions that encode the computational methods described above and can be used to store encoded data, during store operations, and from which encoded data can be retrieved, during read operations, by computer systems, data-storage systems, and peripheral devices.

Although the present invention has been described in terms of particular embodiments, it is not intended that the invention be limited to these embodiments. Modifications within the spirit of the invention will be apparent to those skilled in the art. In particular, various combinations of water-property-detection systems can be employed simultaneously to generate vertical and horizontal conductivity and depth data over a three-dimensional volume of water. For example, water-property-detections systems can be used in various combinations. The detection systems can be suspended from the streamer-data-transmission cables and the lead-in cable or suspended from the transmission cables and the streamers. Combinations can also include one or more water-property-detection systems implemented with paravanes suspended from detection-system cables at different depths, as described above with reference to FIG. 8. FIGS. 11A-11B show side-elevation and top views, respectively, of marine EM survey systems with water-property-detection systems 1102 attached to streamer-data-transmission cables 1104, the streamers 106-111, lead-in cable 118, and suspended from detection-system cables 1106 below the streamers. The detection systems 1102 suspended from detection-system cables 1106 can be implemented with paravanes and the trajectories changed while the survey vessel 102 travels a vessel track. In practice, one or more of the water-property-detection systems 1102 shown in FIG. 11 can be omitted. Each streamer may also have more than one detection system.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A marine survey system comprising:
an electromagnetic (“EM”)-field source to be towed through a body of water;
a streamer having EM-field receivers to be towed through the body of water; and
a water-property-detection system to be towed along a trajectory through the body of water and detect properties of the body of water along the trajectory.

2. The system of claim 1 wherein the water-property-detection system is attached to a portion of the marine survey system selected from the group consisting of: a lead-in cable attached to the EM-field source, a streamer-data-transmission cable attached to the streamer, a detection-system cable attached to a survey vessel, and the streamer.

3. The system of claim 1, wherein the detected properties of the body of water comprise at least one water property selected from the group consisting of: conductivity, temperature, pressure, salinity, sound speed, and depth.

4. The system of claim 1, further comprising a plurality of water-property-detection systems.

5. The system of claim 1 further comprising:
a paravane; and
a detection-system cable attached at one end to a survey vessel and at an opposite end to the paravane, wherein the paravane controls the trajectory of the water-property-detection system.

6. The system of claim 1 wherein the water-property-detection system further comprises at least two sensors selected from the group consisting of: a conductivity sensor, a temperature sensor, and a pressure sensor.

7. The system of claim 1 further comprising a survey vessel to tow the EM-field source, the streamer, and the water-property-detection system through the body of water.

8. The system of claim 1 further comprising:
a first survey vessel to tow the water-property-detection system through the body of water; and
a second survey vessel to tow at least one of the EM-field source and the streamer through the body of water.

9. A method for conducting a marine survey comprising:
towing a water-property-detection system along a trajectory through a body of water above a subterranean formation behind a survey vessel;
towing a EM-field source through the body of water;
towing a streamer through the body of water; and
collecting water-property data with the water-property-detection system and EM-field data with EM-field receivers located on the streamer.

10. The method of claim 9 further comprising calculating electrical properties of the subterranean formation in near-real time based on the water-property data and the EM-field data.

11. The method of claim 10 wherein calculating electrical properties further comprises calculating resistivities of the subterranean formation.

12. The method of claim 9 wherein collecting water-property data further comprises measuring water conductivity along the trajectory at a sampling rate of about 10-40 Hz.

13. The method of claim 9 wherein the water-property data comprise at least one water property selected from the group consisting of: conductivity, temperature, pressure, salinity, sound speed, and depth.

14. The method of claim 9 wherein towing the water-property-detection system further comprises changing the trajectory of the water-property-detection system.

15. The method of claim 9 wherein the water-property-detection system further comprises at least two sensors selected from the group consisting of: a conductivity sensor, a temperature sensor, and a pressure sensor.

16. The method of claim 9 wherein towing the EM-field source and the streamer through the body of water further comprises towing the EM-field source and the streamer behind the survey vessel.

17. The method of claim 9 wherein towing the EM-field source and the streamer through the body of water further comprises
towing the EM-field source and streamer behind a second survey vessel.

18. The method of claim 9 wherein towing the water-property-detection system along the trajectory further comprises towing the water-property-detection system along a trajectory that is substantially parallel to a direction traveled by the survey vessel.

19. The method of claim 9 towing the water-property-detection system along the trajectory further comprises repositioning the water-property-detection system within a plane substantially perpendicular to a direction the survey vessel travels in the body of water.

20. A computer system for processing data obtained from a marine survey comprising:
one or more processors;
one or more data-storage devices; and
a routine stored in one or more of the one or more data-storage devices and executed by the one or more processors, the routine directed to
receiving water-property data that represent properties of a body of water obtained along a trajectory above a subterranean formation;
receiving EM-field data measured by EM-field receivers towed on a streamer through the body of water; and
calculating electrical properties of the subterranean formation based on the water-property data and the EM-field data.

21. The system of claim 20 wherein the water-property data further comprises conductivity data sampled at rate of about 10-40 Hz.

22. The system of claim 20 wherein the water-property data comprise at least one water property selected from the group consisting of: conductivity, temperature, pressure, salinity, sound speed, and depth.

23. The system of claim 20 wherein calculating the electrical properties further comprises calculating electrical properties in near-real time.

24. The system of claim 23 wherein calculating the electrical properties further comprises calculating resistivities of the subterranean formation.

25. The system of claim 20, wherein calculating electrical properties of the subterranean formation based on the water-property data and the EM-field data further comprises calculating resistivities of a subterranean formation.
